(19) United States
(12) Patent Application Publication
(10) Pub. No.: US 2008/0223842 A1
(43) Pub. Date: Sep. 18, 2008

(54) Systems And Methods For Windshield Deicing

(75) Inventors: Victor Petrenko, Lebanon, NH (US); Charles R. Sullivan, West Lebannon, NH (US); Oleg Nickolayev, Redwood Shores, CA (US); Valeri Kozlyuk, Hanover, NH (US)

Correspondence Address: LATHROP & GAGE LC, 4845 PEARL EAST CIRCLE, SUITE 300, BOULDER, CO, 80301, US

(73) Assignee: THE TRUSTEES OF DARTMOUTH COLLEGE, Hanover, NH (US)

(21) Appl. No.: 11/933,160

(22) Filed: Oct. 31, 2007

Related U.S. Application Data
(63) Continuation-in-part of application No. 11/409,914, filed on Apr. 24, 2006.
Application No. 11/409,914 is a continuation of application No. 10/939,289, filed on Sep. 9, 2004, now Pat. No. 7,034,257.
Application No. 10/939,289 is a division of application No. 10/364,438, filed on Feb. 11, 2003, now Pat. No. 6,870,139.
(60) Provisional application No. 60/893,042, filed on Mar. 5, 2007.
(60) Provisional application No. 60/356,476, filed on Feb. 11, 2002.
(60) Provisional application No. 60/404,872, filed on Aug. 21, 2002.
(60) Provisional application No. 60/398,004, filed on Jul. 23, 2002.

(51) Int. Cl. B60S 1/02; B60L 1/02; H05B 3/02

(52) U.S. Cl. 219/203; 219/488

(57) ABSTRACT

Cost efficient, lightweight and rapid windshield deicing systems and methods are disclosed. The systems utilize step-up converters or inverters, or dual-voltage batteries, to provide a voltage high enough to deice a windshield in less than thirty seconds.

### RELATED APPLICATIONS

The present application claims the benefit of priority to co-owned U.S. Provisional Patent Application No. 60/893,042, filed Mar. 5, 2007. This application is also a continuation-in-part of U.S. patent application Ser. No. 11/409,914, filed Apr. 24, 2006, which is a continuation of U.S. patent application Ser. No. 10/939,289, filed Sep. 9, 2004, now U.S. Pat. No. 7,034,257, which is a divisional application of U.S. patent application Ser. No. 10/364,438, filed Feb. 11, 2003 now U.S. Pat. No. 6,870,139, which claims the benefit of U.S. provisional application Ser. No. 60/356,476, filed Feb. 11, 2002; U.S. provisional application Ser. No. 60/398,004, filed Jul. 23, 2002 and U.S. provisional application Ser. No. 60/404,872, filed Aug. 21, 2002. All of the above-referenced applications are incorporated herein by reference.

### RELATED COPENDING APPLICATIONS

The present application is related to copending, co-owned, patent application Ser. Nos. 11/338,239, filed Jan. 24, 2006; PCT/US06/002283, filed Jan. 24, 2006; PCT/US07/069,478, filed May 22, 2007, and Ser. No. 11/571,231, filed Dec. 22, 2006.

### BACKGROUND

Transparent windshields for various vehicles, such as cars, rail vehicles including trains, streetcars, and locomotives, snowmobiles, airplanes, helicopters and sea vessels, must be deiced or defrosted using available on-board power. Typically, deicing and defrosting are accomplished by blowing air heated by the vehicle's engine onto the windshield. However, especially since the engine is initially cold upon startup, deicing/defrosting takes a considerable amount of time.

To deice a windshield in less than thirty seconds, a high voltage (typically over 100V) and high power (typically greater than 3 kW) must be applied to an electrically heated windshield. Common 12V DC power sources, found in most commercial and passenger vehicles, are able to deliver up to 10 kW of power but only into extremely low resistance loads, such as 0.01 ohms. A conductive film windshield heater, to be sufficiently transparent, must have a resistance of over 1 ohm. Thus, traditional 12V power sources are unable to meet the requirements of a rapid windshield deicing system with a transparent windshield heater.

Previous attempts to increase on-board voltage have involved either disconnecting an alternator from a battery and increasing idle rotation speed (see, for instance, U.S. Pat. No. 4,862,055) or feeding a step-up transformer with non-rectified AC current from an alternator (see, for instance, U.S. Pat. No. 5,057,763). In both cases, output power was limited by the size of the alternator such that the voltage necessary for rapid windshield deicing could not be achieved without significant resizing of the alternator. Moreover, since an alternator generates low-frequency power, a step-up transformer of sufficient output power would be heavy and costly to manufacture.

### SUMMARY

The disclosed instrumentalities advance the art by providing cost efficient, lightweight and rapid windshield deicing systems and methods.

In one embodiment, a windshield deicing system includes: a low voltage power source for providing low voltage power; a step-up DC-DC converter for transforming the low voltage power into high voltage DC power; an activating device to enable the step-up DC-DC converter; a windshield heater; and a switch between the step-up DC-DC converter and the windshield heater, the windshield heater being resistively heated when the switch is closed and the high voltage DC power is conducted through the windshield heater.

In one embodiment, a windshield deicing system includes: a low voltage power source for providing low voltage DC power; a step-up DC-AC inverter for transforming the low voltage DC power into high voltage AC power; an activating device for the step-up DC-AC inverter; a windshield heater; and a switch between the step-up DC-AC inverter and the windshield heater, the windshield heater being resistively heated when the DC-AC inverter is active and the switch is closed and the high voltage AC power is conducted through the windshield heater.

In one embodiment, a windshield deicing system includes: a dual-voltage battery for providing low voltage DC power in a low voltage mode and high voltage DC power in a high voltage mode; a first switch disposed between the dual-voltage battery and additional electrical components of a vehicle, the first switch being closed when the dual-voltage battery is in the low voltage mode; and a second switch disposed between the dual-voltage battery and a windshield heater, the second switch being closed and the first switch being open when the dual-voltage battery is in the high voltage mode. An alternative embodiment of dual-voltage battery has multiple low voltage, such as 12-volt, sections. These sections are coupled in parallel for high-current low voltage applications such as vehicle starting. When high-voltage is required, the sections of the battery are coupled in series, but one section remains coupled to low voltage loads to buffer alternator surges and power low current loads such as electronic engine controls.

In one embodiment, a method of deicing a windshield, includes providing low voltage power to electrical components of a vehicle, transforming the low voltage power into high voltage power and providing the high voltage power to a windshield heater to resistively heat the windshield heater and deice a surface of the windshield.

### BRIEF DESCRIPTION OF THE DRAWINGS

FIG. 1 illustrates one exemplary windshield deicing system embodiment having a step-up DC-DC converter.

FIG. 2 illustrates an exemplary circuit of the step-up DC-DC converter of FIG. 1.

FIG. 3 illustrates one exemplary windshield deicing system embodiment having a step-up DC-AC inverter.

FIG. 4 illustrates one exemplary windshield deicing system embodiment having a dual-voltage battery.

FIG. 5 illustrates exemplary circuitry of the dual-voltage battery of FIG. 4.

FIG. 6A shows one exemplary configuration of an inter-battery switch used in the dual-voltage battery of FIG. 4.

FIG. 6B shows another exemplary configuration of an inter-battery switch used in the dual-voltage battery of FIG. 4.

FIG. 7 shows a cross-sectional view of one exemplary windshield embodiment having windshield heaters disposed on outer surfaces of glass layers of the windshield.

FIG. 8 shows a cross-sectional view of one exemplary windshield embodiment having windshield heaters disposed between a polyvinyl butyral (PVB) layer and glass layers of the windshield.

FIG. 9 shows a cross-sectional view of one exemplary windshield embodiment incorporating features from both FIG. 7 and FIG. 8.

### DETAILED DESCRIPTION OF THE DRAWINGS

As used herein the terms deicing and defrosting shall be used interchangeably to refer to a process that removes frozen water from a surface. The frozen water may be of any form. For example, the frozen water may be present as a solid layer of ice or as ice crystals adhered to the surface.

The windshield deicing systems disclosed herein provide a high density of heating power (W/m²), which allows for rapid and energy-efficient deicing. Rapid heating insures that only a thin layer of ice (e.g., less than 1 cm, or less than 0.5 cm, or between 1 μm and 1 mm) at the ice/windshield interface is heated to the ice melting point. Thus, remote parts of the windshield and of the ice are not unnecessarily heated, and minimal energy is lost to the surrounding environment. This concept is further described in U.S. Pat. Nos. 6,870,139 and 7,034,257, which are each incorporated herein by reference. As shown in these patents, the higher the density of heating, the less energy is needed to accomplish deicing.

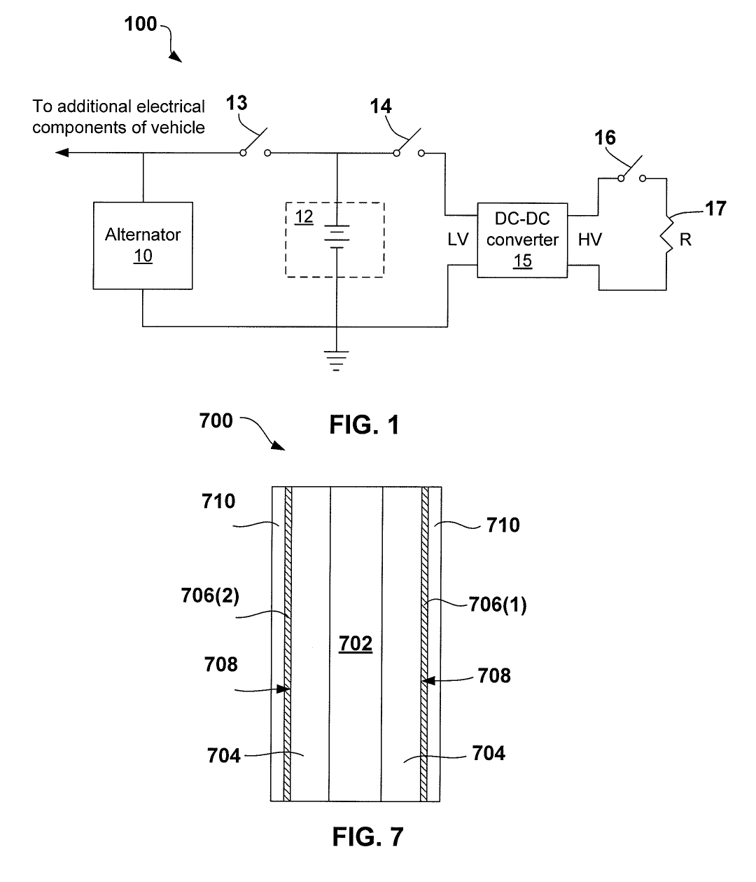

FIG. 1 shows a windshield deicing system 100 including an alternator 10, a battery 12, a step-up DC-DC converter 15, a windshield heater 17, and switches 13, 14 and 16. In normal vehicle operation, switch 13 is closed and switches 14 and 16 are open. During deicing, switch 13 may be either open or closed and switches 14 and 16 are closed. In the deicing configuration, the step-up DC-DC converter 15 converts low voltage direct current (DC) power (for instance, 12V DC) from battery 12, or from battery 12 and alternator 10, into high voltage DC power (typically from 70V to 300V, or from 40V to 1000V). The high voltage is used to power windshield heater 17, which generates heat due to electrical resistance, R.

In an alternative embodiment, switch 14 is replaced with a high-current fuse. In embodiments having switch 14, closure of switch 14 activates the DC-DC converter. In embodiments lacking switch 14, a control input is provided to the DC-DC converter 15 is provided that, in one state, enables the DC-DC converter, and in another state disables internal switching transistors of an input DC-AC section of the DC-DC converter, thereby preventing the DC-DC converter from drawing power from the battery.

One advantage of system 100 is that battery 12 alone, or together with alternator 10, can supply heater 17 with more power than alternator 10 alone. A typical 12V battery, as fitted in a car for example, is capable of supplying from 7 kW to 10 kW for up to about thirty seconds without being damaged. Thirty seconds of 7 kW power is sufficient to deice a windshield, and battery 12 may be recharged by alternator 10 between such deicing events.

Another advantage of system 100 is that, due to the use of high voltage and high power, the duration of deicing is short (e.g., less than thirty seconds at T≧10° C.), compared to most prior-art deicing systems. Step-up DC-DC converter 15 may thus be of smaller size and lower cost than similar converters designed for continuous operation at the same power level. For example, the transformer and its windings within step-up DC-DC converter 15 may be of smaller size, lower-grade magnetic materials may be used, and larger losses may be allowed in semiconductor devices, such as MOSFET switches and diodes, used to rectify the high voltage current of the step-up DC-DC converter. Similarly, smaller heat-sinks and fewer and smaller cooling devices, such as cooling fans, may be used on the semiconductor devices than would be required for continuous operation.

A further advantage of deicing system 100 is that battery 12 and DC-DC converter 15 may be electrically separated from alternator 10 and other electric components of the vehicle by opening switch 13. Opening switch 13 may thus prevent damage to the vehicle's electronics when power is drawn from battery 12 and from high frequency harmonics that may be generated by DC-DC converter 15.

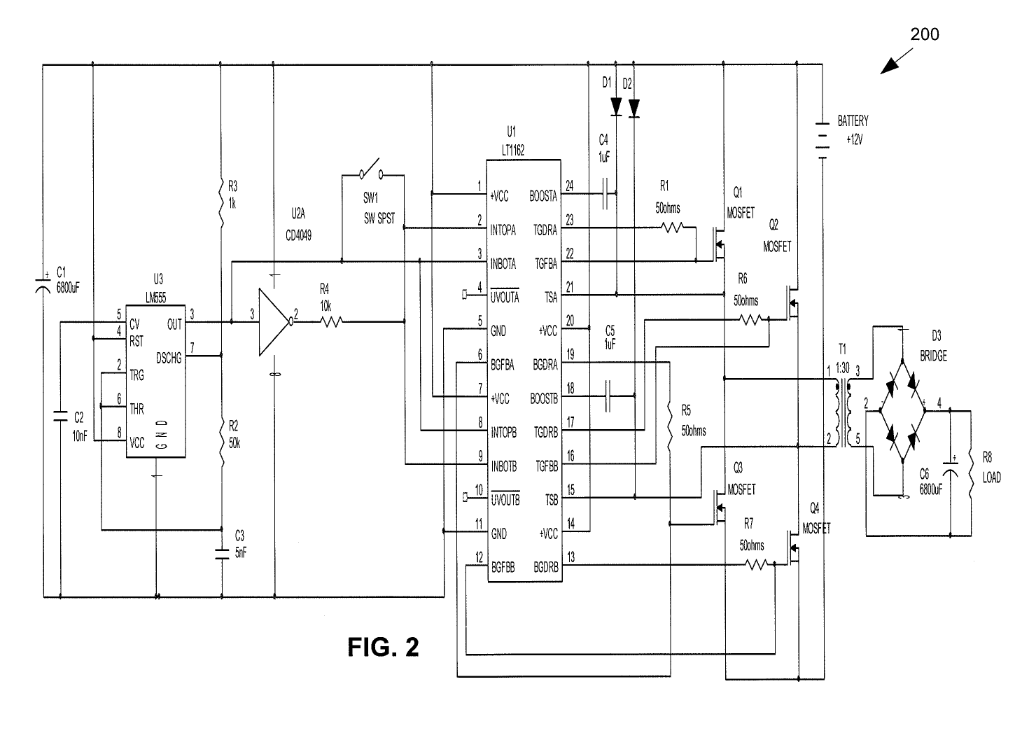

For illustrative purposes, FIG. 2 shows one exemplary circuit 200 of step-up DC-DC converter 15 of FIG. 1. Circuit 200 is a full-bridge DC-DC converter, but other types of step-up DC-DC converters, such as a half-bridge DC-DC converter, may be used in system 100.

It will be appreciated that switches 13, 14, and 16 may be mechanical, electromagnetic, solid-state semiconductor switches or a combination thereof. Further, switches 13, 14, and 16 may be replaced by short circuits without departing from the scope hereof. Without switches 14 or 16, other methods must be used for activating or deactivating the DC-DC converter, such as an electronic control signal to the control circuitry of the DC-DC converter to activate the heating pulse.

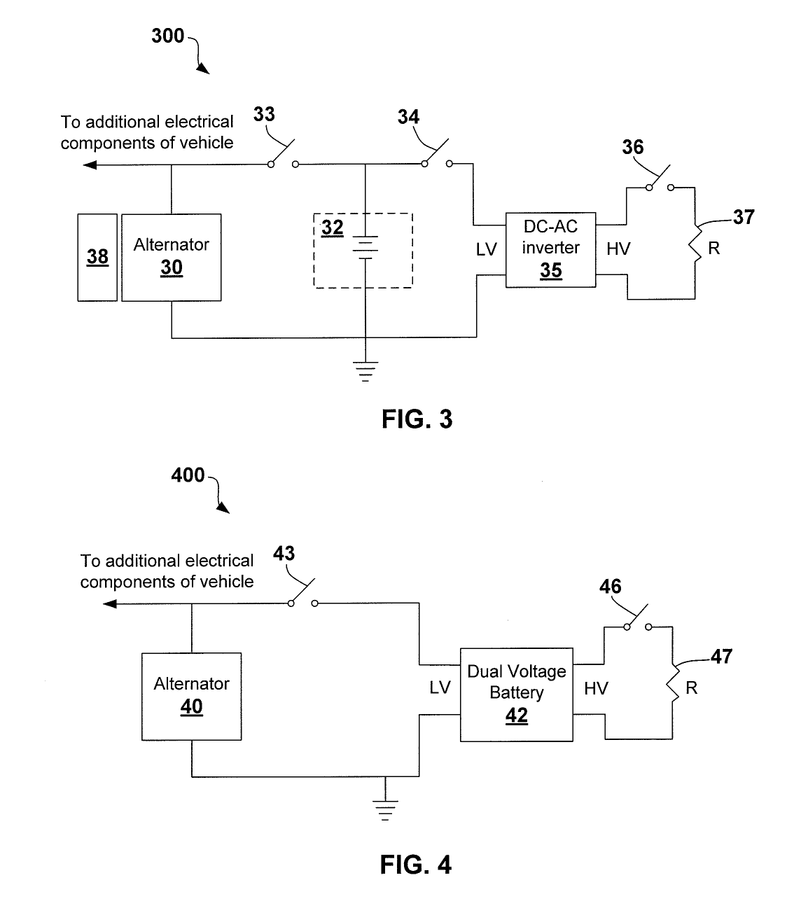

In an embodiment, DC-DC converter 15, or DC-AC inverter 35 (FIG. 3) operates at full power for initial defrosting of the windshield. Once the windshield is defrosted, the DC-DC converter 15, or DC-AC inverter 35 operates in a reduced-power-output mode to maintain the windshield in a defrosted condition. This reduced-power-output mode is either operation at a reduced voltage output, or a pulsed operation. For example, a windshield heater that absorbs 1 kilowatt at 500 volts will absorb only 250 watts at 250 volts; similarly the same windshield heater that is operated by a converter that provides 1 kilowatt for only one quarter of each second will absorb an average power of only 250 watts.

FIG. 3 shows one exemplary windshield deicing system 300 including an alternator 30, a battery 32, a step-up DC-AC inverter 35, a windshield heater 37, and switches 33, 34 and 36. During normal vehicle operation, switch 33 is closed and switches 34 and 36 are open. During deicing, switch 33 may be either open or closed and switches 34 and 36 are closed. For the deicing operation, step-up DC-AC inverter 35 inverts low voltage DC power (for instance, 12V) taken from battery 32, or from battery 32 and alternator 30, into high voltage AC power (typically from 70V to 300V, or from 40V to 1000V) to power windshield heater 37, which produces heat due to electrical resistance, R. A typical range of AC frequencies for system 300 is from about 50 Hz to about 150 kHz.

As previously stated with reference to the DC-DC converter 15, other circuitry for enabling the DC-AC inverter 35 may be used in place of switch 34.

One advantage of system 300 is that battery 32 alone, or together with alternator 30, can supply windshield heater 37 with more power than alternator 30 alone. A regular 12V battery is capable of supplying from 7 kW to 10 kW for up to about thirty seconds without being damaged. Thirty seconds is sufficient to deice a windshield, and battery 32 may be recharged by alternator 30 between deicing events.

Another advantage of system 300 is that, due to the use of high voltage the duration of deicing is short (e.g., less than thirty seconds at T≧10° C.). Step-up DC-AC inverter 35 may thus be of smaller size and lower cost than similar inverters designed for continuous operation at the same power level. For example, the transformer and its windings within DC-AC inverter 35 may be of smaller size, lower-grade magnetic materials may be used for its step-up transformer, and larger losses may be allowed in semiconductor devices, such as MOSFET switches and diodes, used to rectify the high-voltage current of the DC-AC inverter.

Further, since de-icing typically takes place with a cold engine idling, fast de-icing times will help conserve fuel and minimize pollutant gas emissions from the vehicle.

Yet another advantage of deicing system 300 is that battery 32 and DC-AC inverter 35 may be electrically separated from alternator 30 and other electric components of the vehicle when switch 33 is open. Opening switch 33 may prevent damage to the vehicle's electronics when power is drawn from battery 32, and from high frequency harmonics that may be generated by DC-AC inverter 35, especially if load-dump surge-suppression circuitry or auxiliary battery 38 is provided. Since abrupt disconnection of even a 12-volt battery from an alternator charging the battery at high current can cause surges exceeding 100 volts, suppression circuitry or auxiliary battery 38 is recommended.

It will be appreciated that DC-DC converter 15 (FIG. 2) may be an example of a step-up DC-AC inverter 35 after removal of the bridge-rectifier connected between the secondary winding of the step-up transformer and windshield heater 17, 37.

It will further be appreciated that switches 33, 34, and 36 may be mechanical, electromagnetic, solid-state semiconductor switches or a combination thereof. Further, switch 34 may be replaced by a short circuit without departing from the scope hereof provided alternative apparatus for enabling the system is provided, and switches 33 and 36 may be replaced by short circuits in some embodiments.

FIG. 4 illustrates a windshield deicing system 400 having a dual-voltage battery 42 to be used as a high-power/high-voltage source for rapid windshield deicing. System 400 includes an alternator 40, dual-voltage battery 42, a windshield heater 47 and switches 43 and 46. During normal vehicle operation, battery 42 is set to a low voltage mode (for instance, 12V), switch 43 is closed and switch 46 is open. During deicing, switch 43 is open, battery 42 is set to a high-voltage mode (for instance, 70V to 300V, or from 40V to 1000V) and switch 46 is closed.

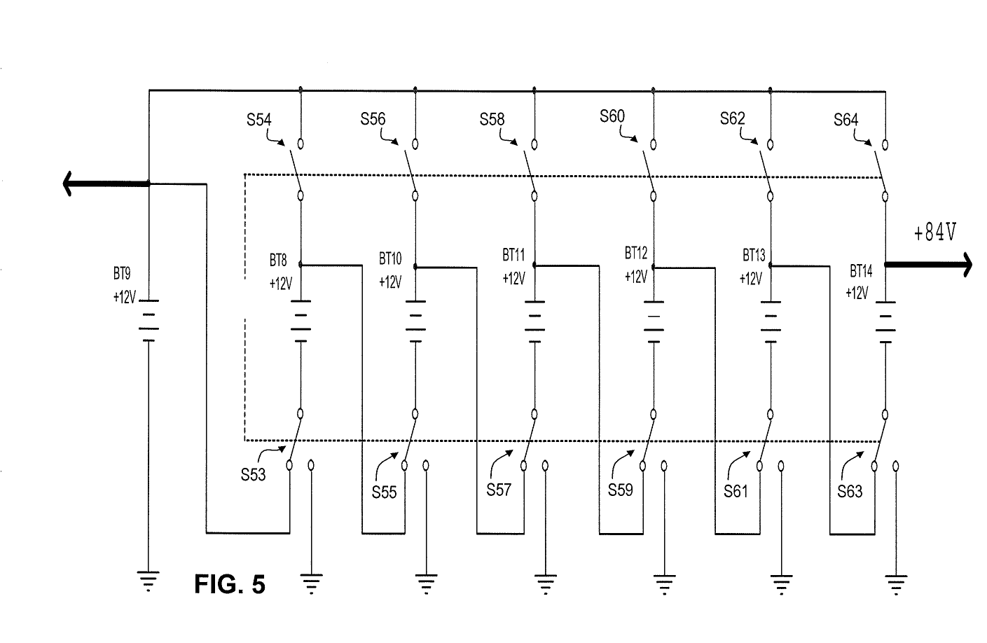

Dual-voltage batteries are disclosed, for example, in U.S. Pat. Nos. 3,667,025 and 4,114,082, which are incorporated herein by reference. Typically, a dual-voltage battery is formed of a bank of smaller batteries. FIG. 5 illustrates exemplary principle circuitry of dual-voltage battery 42, which may, for example, provide 12V power in low voltage mode and 84V power in high voltage mode. It will be appreciated that other voltage limits may be achieved by providing different types or numbers of batteries in the bank. When the batteries are connected in parallel, dual-voltage battery 42 delivers the same voltage as each individual battery, e.g., 12V, and is capable of delivering high current. In high voltage mode, the batteries are connected in series, and dual-voltage battery 42 is capable of delivering high voltage that is approximately equal to the sum of the voltages of the individual batteries. Switching between high voltage and low voltage modes may be accomplished by simultaneously triggering switches S53-S64. Connections shown in FIG. 5 correspond to the high voltage mode.

It will be further appreciated that the systems of FIGS. 1, 3, and 4 are capable of providing continuous lower-than-maximum heating power by switching periodically between an off state, the low-voltage configuration and the high-voltage configuration. Depending on a duty cycle, that average heating power can be adjusted to any desirable magnitude in between 0 W and a maximum power, which the high voltage configuration can provide. For instance, if the high-power configuration supplies 5 kW of peak power, when 10% duty cycle is used (for instance being for 0.1 s in the high-voltage mode and for 0.9 s in the low-voltage configuration over each one-second period) the system will apply 0.1*5 kW=500 W heating power to a windshield heater.

It should be further appreciated that when such intermittent mode is used for system of FIG. 4, the battery is recharged in between the heating duty cycles from an alternator.

One advantage of system 400 is that dual-voltage battery 42 is similar in size and weight to a regular low voltage battery, but it is capable of supplying windshield heater 47 with sufficient power to perform rapid windshield deicing.

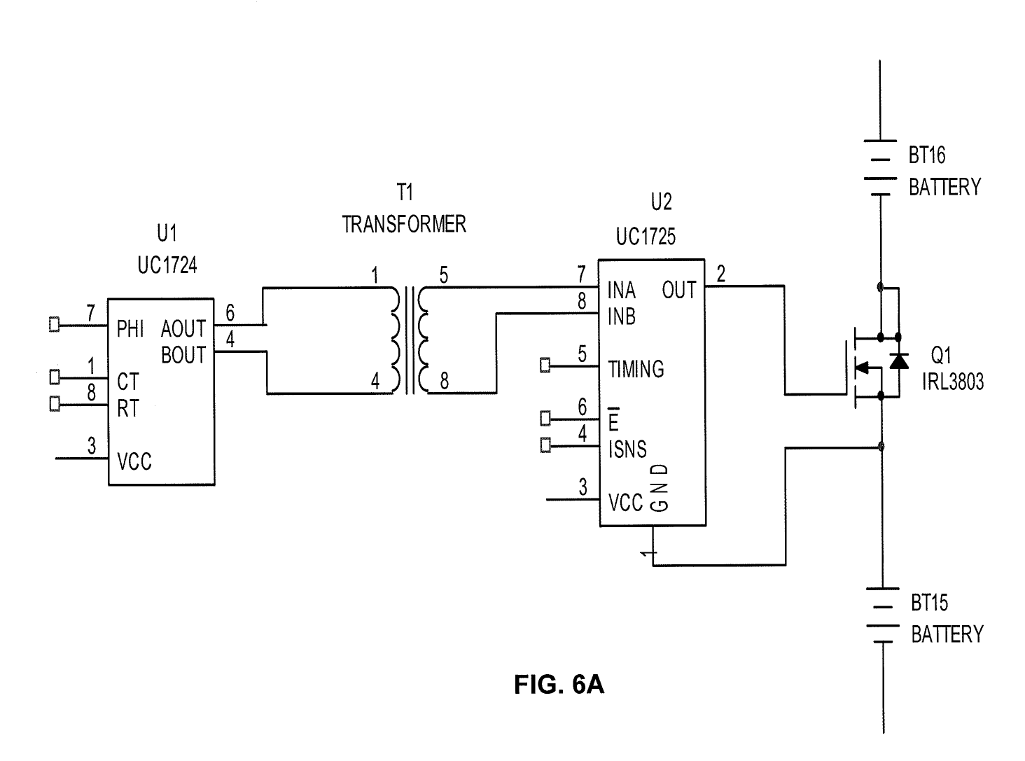

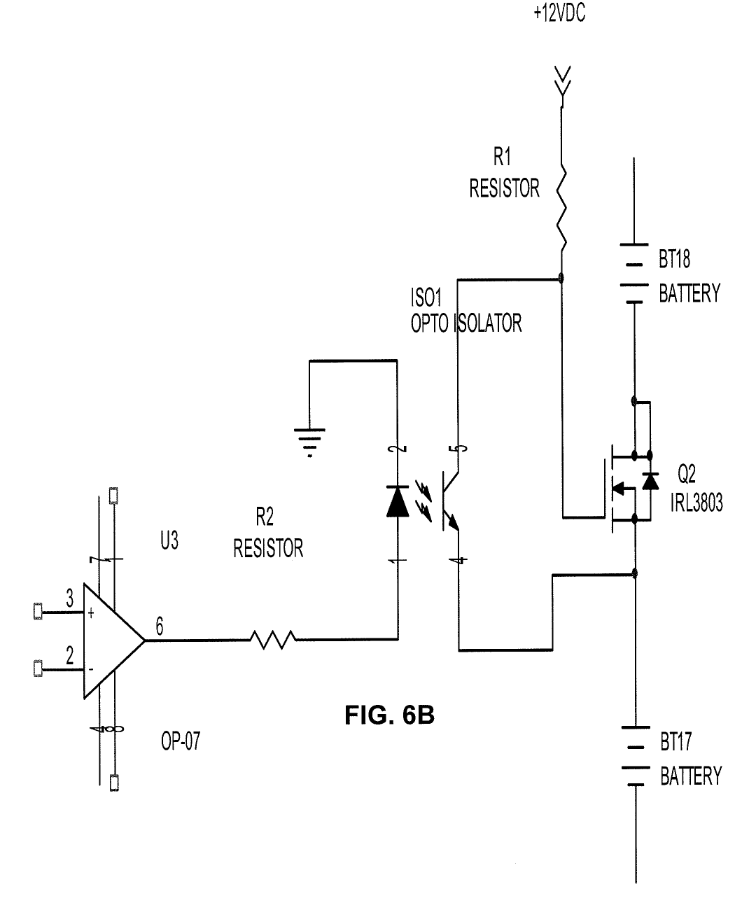

It will be appreciated that switches (43, 46 and 53-64) of FIGS. 4 and 5 may be mechanical, electromagnetic, solid-state semiconductor switches or a combination thereof. Two examples of possible battery switches are shown in FIGS. 6A and 6B. For example, the switch shown in FIG. 6A is based on an isolated high side FET driver, while the switch shown in FIG. 6B is based on an opto isolator driver.

Batteries 12, 32 and 42 of windshield deicing systems 100, 300 and 400 may be lead-acid batteries, Li-ion batteries, Ni-metal hydride batteries, or any other electrochemical type of battery known in the art.

In one embodiment, windshield heaters 17, 37 and 47 are continuous film metal-oxide transparent coatings made of indium-tin-oxide (ITO), zinc-oxide, tin-oxide or any other electrically conductive, transparent, film made of a single metal oxide or a composite of several metal oxides.

In another embodiment, windshield heaters 17, 37 and 47 are thin optically transparent metal films made of silver, aluminum, gold or the like, or of an electrically conductive and optically transparent polymer material.

FIG. 7 shows a cross-sectional view of a windshield 700. Windshield 700 comprises a polyvinyl butyral (PVB) shatter-resistant plastic layer 702 laminated between two layers of glass 704. Windshield heaters 706 are then disposed on outer surfaces 708 of glass layers 704, and dielectric layers 710 are disposed on windshield heaters 706. Dielectric layers 710 increase safety, as well as provide scratch protection for windshield heaters 706. Windshield heater 706(1) deices windshield 700, and windshield heater 706(2) defogs windshield 700.

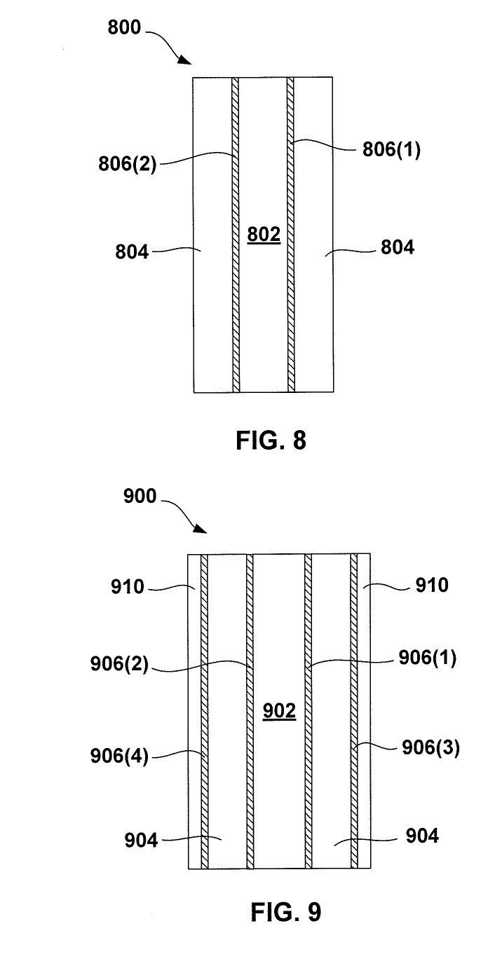

FIG. 8 shows a cross-sectional view of a windshield 800. Windshield 800 comprises windshield heaters 806 disposed between a polyvinyl butyral (PVB) shatter-resistant plastic layer 802 and glass layers 804. Windshield heater 806(1) deices windshield 800, and windshield heater 806(2) defogs windshield 800. It is appreciated that future windshields may be made of safety glass incorporating a shatter-resistant plastic layer of plastics other than PVB.

FIG. 9 shows a cross-sectional view of a windshield 900 having features in common with both windshield 700 and windshield 800. Windshield 900 includes a polyvinyl butyral (PVB) layer 902, a first pair of windshield heaters 906(1) and 906(2), glass layers 904, a second pair of windshield heaters 906(3) and 906(4), and dielectric layers 910. Windshield heaters 906(2) and 906(4) may be electrically connected, and operate to defog windshield 900, while windshield heaters 906(1) and 906(3), which may be electrically connected, operate to deice/defrost windshield 900.

In one embodiment, the area of a windshield may be segregated into multiple sections, each section containing a windshield heater (such as windshield heaters 17, 37, 47, 706, 806, 906) that is electrically insulated from neighboring heaters/sections. Application of power to a windshield heater having a smaller area than the entire area of the windshield provides for application of the entire heating power to a relatively concentrated area. The entire area of the windshield may be deiced one section at a time.

### EXAMPLE

As discussed above, the main obstacle to rapid windshield deicing using conventional systems is insufficient on-board voltage. The following calculations further illustrate this point.

Typical windshield and ice parameters are shown in Table 1.

TABLE 1

| | R₂ = 10 ohm |
|---|---|
| ITO coated solid-glass windshield | (sheet resistance) |
| Windshield area | A = 1.5 m² |
| Windshield aspect ratio | r = 1.5 |
| Ice thickness | t_{ice} = 6 mm |
| Effective windshield-glass | t_{glass} = 5 mm |
| thickness | |
| Ambient temperature | T_{amb} = −10° C. |
| Ice melting point | Tₘ = 0° C. |
| Glass density | ${ρ}_{glass} = 2500 \frac{kg}{{m}^{2}}$ |
| Heat capacity of glass | ${C}_{g} = 750 \frac{Joule}{kg \cdot ° C .}$ |
| Ice density | ρ_{ice} = 920 kg./m³ |
| Heat capacity of ice | ${ρ}_{ice} = 2200 \frac{J}{kg \cdot ° C .}$ |

For a windshield with electric bus-bars placed on the top and bottom of the windshield, the windshield electric resistance is:

R=R_{□}/r=6.67 ohm (1)

The heating density of the windshield, utilizing a 12V source, is:

$$W = \frac{P}{A} = \frac{{V}^{2} \cdot r}{R \cdot A} = \frac{{V}^{2} r}{{R}_{•} A} = 14.4 \frac{W}{{m}^{2}} , \qquad ( 2 )$$

where P is the power. At such a low density of heating power, the windshield cannot be heated from −10° C. to 0° C., even in still air, because a cooling convective heat transfer rate of about

$$h \approx 5 \frac{watt}{{m}^{2} \cdot °C .}$$

provides a cooling power rate of:

$${W}_{conv} \approx h \cdot Δ T \approx 50 \frac{watt}{{m}^{2}} , \qquad ( 3 )$$

where ΔT=Tₘ−T_{amb}=10° C. Thus, the cooling power rate exceeds the heating power rate by a factor of about three.

Even when transparent conductive coatings having lower resistance than ITO are used, e.g., thin silver coatings with sheet resistivity R=2 ohm, the time necessary to warm glass to the ice melting point is estimated as:

$$t = \frac{( {C}_{g} \cdot {m}_{g} + {C}_{ice} \cdot {m}_{ice} ) Δ T}{P} \approx 3200 s , \qquad ( 4 )$$

where the heating power for the silver coating is equal to P=108 W.

In reality, the deicing time t would be even longer than that calculated by eqn. (4) due to convective cooling and additional energy necessary to melt a layer of ice at the windshield/ice interface. When the thickness of the layer of ice melted is only 100 μm, the deicing time t increases by an additional 400 s. The total deicing time is thus 3600 s, or 60 minutes.

According to eqn. (4), rapid deicing (t≦30 s) would require an increase of the heating power by a factor of about 100. Thus, an increased voltage of about 100V would be needed for a silver-based transparent conductor, and about 200V to 300V for an ITO-based transparent conductor.

The deicing systems and methods disclosed herein are capable of providing voltage within the necessary range.

Since the DC-DC or DC-AC converter described herein for driving the transparent conductor is capable of producing electrical voltages at high current that could be hazardous to human health, it is anticipated that the converter either be potted with an insulating potting compound as known in the art, or have a safety interlock on its cover. Further, the connectors in wiring from the output terminal of the converter to the windshield should be of a type that does not leave exposed any uninsulated metal pins whether one or more of the connectors are in connected or disconnected condition. In embodiments with the resistive conductive film on the outer surface of the windshield, there should also be a thin insulating coating, or dielectric layer, over the transparent conductor layer on the windshield to prevent these voltages from contacting curious fingers.

In some embodiments having a DC-AC converter, a dual-voltage battery, or a DC-DC converter, wires of opposite polarity for attachment at opposite sides of the windshield are coupled to the windshield from the converter or battery through circuitry for detecting ground fault currents that may be lost through a resistive short circuit, such as a human, to vehicle ground; when such lost current is detected the high voltage power is immediately shut down or disconnected as to interrupt the ground fault. In other embodiments, the high-voltage output of the converter or battery is electrically isolated from the vehicle ground to reduce the possibility of a current through a human or other path to ground. In some of these isolated embodiments, an isolation monitor circuit is used to verify the integrity of the isolation and to immediately shut down or disconnect the high voltage if a fault is detected. In some embodiments, the converter or dual-voltage battery is also disabled or disconnected during vehicle conditions where human contact with the windshield is particularly likely, such as when a door is open or the engine is off.

Everything herein stated with reference to 12 volt systems, such as used in current production automobiles, is equally applicable to 24 volt systems as frequently used on trucks and recent production light aircraft, as well as to system using other battery voltages such as emerging 42 volt automotive systems.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

We claim:

1. A windshield deicing system, comprising:
a low voltage power source for providing low voltage power;
a step-up converter selected from the group consisting of a DC-DC converter and a DC-AC inverter for transforming the low voltage power into high voltage power;
apparatus for enabling the step-up converter; and
a windshield heater, the windshield heater being resistively heated when the converter is enabled and the high voltage power is conducted through the windshield heater.

2. The system of claim 1, wherein the low voltage power source comprises a vehicle battery.

3. The system of claim 1, wherein the windshield heater is disposed on an outer surface of the windshield, and wherein a dielectric layer is disposed over the windshield heater.

4. The system of claim 3, further comprising apparatus for sensing ground fault currents and for interrupting current from the step-up converter when ground fault currents are detected.

5. The system of claim 3, wherein the high voltage power from the step-up converter is isolated from vehicle ground, and further comprising:
apparatus for monitoring integrity of isolation of the high voltage power from ground, and
apparatus for interrupting the high voltage power when a failure of the isolation is detected.

6. The system of claim 1, wherein at least one windshield heater is disposed between a shatter resistant plastic layer and a glass layer.

7. The system of claim 1, wherein the windshield forms part of a vehicle selected from the group consisting of a car, a truck, a rail vehicle, a snowmobile, an airplane, a helicopter or a ship.

8. The system of claim 1, wherein the step-up converter provides the windshield heater with a heating power having a power density in a range from
$$500 \frac{W}{{m}^{2}}$$
to
$$100 \frac{kW}{{m}^{2}} ,$$
where W is power in watts, and m² is an area of the heater in square meters.

9. The system of claim 1, wherein an output voltage of the step-up converter is in a range from 40 V DC to 1000V.

10. The system of claim 1, wherein the windshield heater is selected from an optically transparent metal film, an optically transparent metal oxide, a composite of metal oxides and an optically transparent and electrically conductive polymer material.

11. The system of claim 1, wherein the windshield heater comprises a plurality of sections, each section of which can be powered independently from neighboring sections.

12. The system of claim 1 wherein the step-up converter has a full-power mode wherein it operates continually until the windshield is defrosted, and a reduced power mode selected from the group consisting of intermittent operation and operation at a reduced output voltage of the step-up converter.

13. A windshield deicing system, comprising:
a dual-voltage battery for providing low voltage DC power in a low voltage mode and high voltage DC power in a high voltage mode; and
a switch disposed between the dual-voltage battery and a windshield heater, the switch being closed when the dual-voltage battery is in the high voltage mode and the windshield heater is active,
and wherein the windshield forms part of a vehicle selected from a car, a truck, a rail vehicle, a snowmobile, an airplane, a helicopter or a ship.

14. The system of claim 13, wherein the dual-voltage battery comprises a plurality of batteries, the batteries being connected in parallel in the low voltage mode, and wherein the batteries are connected in series in the high voltage mode.

15. The system of claim 13, wherein the dual-voltage battery provides a voltage in a range of 40V to 360V in the high voltage mode; and wherein the dual-voltage battery provides the windshield with a heating power having a power density in a range from
$$500 \frac{W}{{m}^{2}}$$
to
$$100 \frac{kW}{{m}^{2}} .$$

16. The system of claim 13, wherein the windshield heater is disposed on an outer surface of a glass layer of the windshield, and wherein a dielectric layer is disposed over the windshield heater.

17. The system of claim 16, further comprising apparatus for sensing ground fault currents and for disabling or disconnecting the high-voltage DC power from the windshield heater when ground fault currents are detected.

18. The system of claim 16, wherein the high voltage DC power is isolated from vehicle ground when it is in high-voltage mode.

19. The system of claim 16, further comprising apparatus for monitoring the integrity of isolation of the high voltage DC power from ground and for disconnecting the high-voltage DC power from the windshield heater when a failure of isolation is detected.

20. The system of claim 13, wherein at least one windshield heater is disposed between a shatter resistant plastic layer and a glass layer.

21. The system of claim 13, wherein the windshield heater is selected from an optically transparent metal film, an optically transparent metal oxide, a composite of metal oxides and an optically transparent and electrically conductive polymer material.

22. The system of claim 13, wherein the windshield heater comprises a plurality of sections, each section electrically isolated from neighboring sections, and wherein the high voltage DC power is separately applied to each section.

23. A method of deicing a windshield, comprising:
providing a source of low voltage power;
transforming the low voltage power into high voltage power; and
providing the high voltage power to a windshield heater to resistively heat the windshield heater and deice a surface of the windshield.

24. The method of claim 23, wherein the step of transforming the low voltage power into high voltage power comprises switching a dual-voltage battery from a parallel configuration into a series configuration.

25. The method of claim 23, wherein the step of transforming the low voltage power into high voltage power comprises utilizing a step-up converter selected from the group consisting of a DC-DC converter and a DC-AC inverter.
